(19) United States
(12) Patent Application Publication
(10) Pub. No.: US 2002/0059712 A1
(43) Pub. Date: May 23, 2002

(54) Combination mobile computer shell and its fabrication method

(76) Inventor: Hong-Line Chern, Taipei (TW)

Correspondence Address: ROSENBERG, KLEIN & LEE, SUITE 105, 3444 ELLICOTT CENTER DRIVE, ELLICOTT CITY, MD, 21043, US

(21) Appl. No.: 10/026,786

(22) Filed: Dec. 27, 2001

Related U.S. Application Data
(62) Division of application No. 09/558,873, filed on Apr. 28, 2000.

(51) Int. Cl. B23P 11/00

(52) U.S. Cl. 29/525.01

(57) ABSTRACT

A method of fabricating a mobile computer shell by: stamping, milling and drilling a metal sheet member into a shaped shell, fixedly securing different positioning members to the shaped shell at locations subject to the computer parts to be held by means of bonding or welding, and covering a plastic cover sheet on the shaped shell after the installation of the positioning members in the shaped shell.

### BACKGROUND OF THE INVENTION

The present invention relates to a combination mobile computer shell and its fabrication method. According to the fabrication method of the invention, a metal sheet member is processed into the desired shape, and then different positioning members are respectively fastened to the shaped metal sheet member, and then a plastic cover is covered on the shaped metal sheet member.

Regular mobile computer shells are commonly injection-molded from plastics. Because a mobile computer shell must have positioning means for holding computer parts, it is difficult to form positioning means on the shell during the process of injection molding. Further, a plastic mobile computer shell has less strength against impact, and low heat dissipation and electromagnetic interference protection power.

### SUMMARY OF THE INVENTION

The present invention has been accomplished under the circumstances in view. It is one object of the present invention to provide a combination mobile computer shell, which provides satisfactory heat dissipation power. It is another object of the present invention to provide a combination mobile computer shell, which eliminates electromagnetic interference. It is still another object of the present invention to provide a combination mobile computer shell, which provides high impact resistance. It is still another object of the present invention to provide a combination mobile computer shell, which effectively protects the internal parts of the mobile computer against dust when the mobile computer is closed. According to one aspect of the present invention, a combination mobile computer shell is made by: processing a metal sheet member into a shaped shell, fastening different positioning members to the shaped shell for holding different computer parts, and covering the shaped shell with a plastic cover. According to another aspect of the present invention, the positioning members are fastened to the shaped shell by gluing, welding, or screw means subject to their strength.

### BRIEF DESCRIPTION OF THE DRAWINGS

FIG. 1 is a mobile computer shell fabrication flow chart according to the present invention.

FIG. 2 illustrates a mobile computer shell constructed according to the present invention.

FIG. 3 shows the mobile computer shell of FIG. 2 opened.

### DETAILED DESCRIPTION OF THE PREFERRED EMBODIMENT

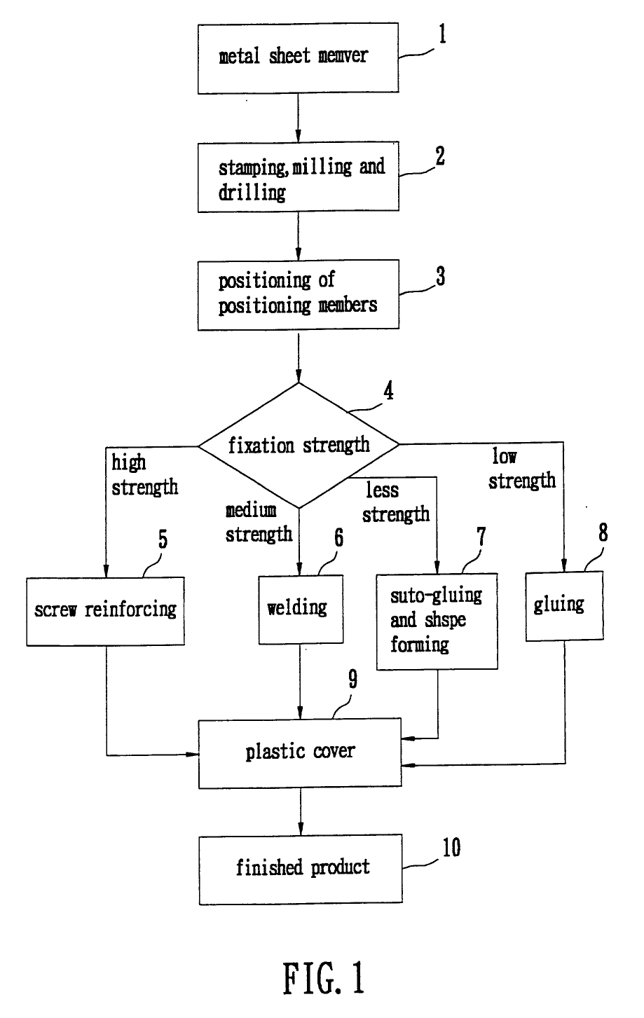

Referring to FIG. 1, a mobile computer shell fabrication method according to the present invention comprises the steps of:

(1) selecting a metal sheet member, for example, magnesium or aluminum alloy sheet member for making a mobile computer shell;

(2) stamping, milling and drilling the metal sheet member into a shaped shell subject to a predetermined pattern;

(3) putting positioning members on the shaped shell thus obtained at locations subject to the computer parts to be installed;

(4) selecting suitable fastening methods or means to fixedly secure the positioning members to the shaped shell subject to the conditions of: using a glue to secure plastic positioning members of low strength to the shaped shell; using a shape-forming and bonding technique to fixedly secure positioning members of less strength to the shaped shell; using a welding technique to secure metal positioning members of medium strength (for example, screw nuts or the like) to the shaped shell; using screws to reinforce the fixation between metal positioning members of high strength and the shaped shell for supporting important computer parts against impact;

(5) fixedly fastening the positioning members to the shaped shell subject to the fastening methods selected in step (4); and

(6) covering a plastic cover on the shaped shell having positioning members installed therein.

Because the shell and the positioning members are separately made, the fabrication of the shell is simple and easy. Further, because the shaped shell is a metal member, it has high compact strength, and can effectively isolate internal as well as external electromagnetic waves.

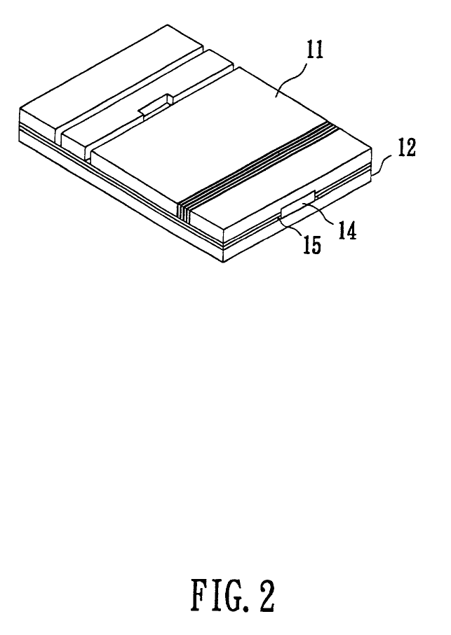

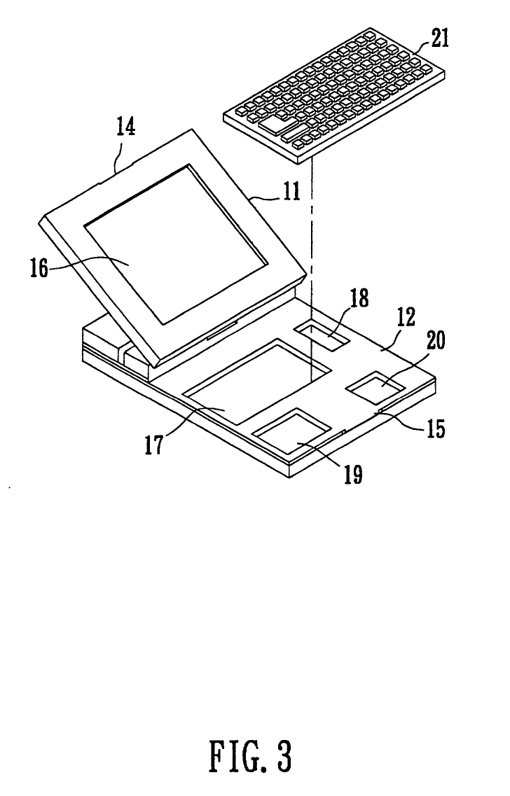

Referring to FIGS. 2 and 3, a mobile computer shell in accordance with the present invention comprises a top cover 11 for holding a display module 16, a bottom cover 22 for holding a mother board 17, a disk drive 18, a CD-ROM player 19, a battery box 20 and a keyboard 21, a hinge 13 coupled between the top cover 11 and the bottom cover 22 for enabling the top cover 11 and the bottom cover 22 to be turned relative to each other between the close position and the open position, a male positioning member (for example, a springy plastic hook) 14 provided at one side of the top cover 11, and a female positioning member (for example, a retaining groove) 15 provided at one side of the bottom cover 22 for engagement with the male positioning member 14 at the top cover shell 11 to secure the top cover 11 and the bottom cover 22 in the close position, preventing dust and external electromagnetic waves from passing to the inside of the mobile computer and internal electromagnetic waves from passing to the outside of the mobile computer.

It is to be understood that the drawings are designed for purposes of illustration only, and are not intended for use as a definition of the limits and scope of the invention disclosed. For example, a positioning member can be a single element, or an assembly of a number of plate-like and/or meshed elements. Further, the mobile computer shell can be designed for use with a notebook computer, palm-top computer, electronic dictionary, PDA, . . . and etc.

What the invention claimed is:

1. A mobile computer shell fabrication method comprising the steps of:
(a) selecting a metal sheet member, for making a mobile computer shell;
(b) stamping, milling and drilling said metal sheet member into a shaped shell subject to a predetermined pattern;
(c) putting desired positioning members on the shaped shell thus obtained at locations subject to computer parts to be held;
(d) selecting different fastening methods to fixedly secure said positioning members to said shaped shell subject to the strength of said positioning members;
(e) fixedly fastening said positioning members to said shaped shell subject to the fastening methods selected in step (d); and
(f) covering a plastic cover on said shaped shell after the installation of said positioning members in said shaped shell.

2. The mobile computer shell fabrication method of claim 1 wherein said metal sheet member is a magnesium alloy sheet member.

3. The mobile computer shell fabrication method of claim 1 wherein said metal sheet member is an aluminum alloy sheet member.

4. The mobile computer shell fabrication method of claim 1 wherein said positioning members include at least one plastic hook.

5. The mobile computer shell fabrication method of claim 1 wherein said positioning members include at least one screw nut.

6. The mobile computer shell fabrication method of claim 1 wherein

7. A mobile computer shell comprising a top cover, a bottom cover, a hinge coupled between said top cover and said bottom cover for enabling said top cover and said bottom cover to be turned relative to each other between a first position where said top cover and said bottom cover are closed, and a second position where said top cover and said bottom cover are opened, a male positioning member provided at one side of said top cover, and a female positioning member provided at one side of said bottom cover for engagement with said male positioning member to secure said top cover and said bottom cover in said first position.

8. The mobile computer shell of claim 7 wherein said top cover has at least one positioning member for holding a display module.

9. The mobile computer shell of claim 7, which is used for a notebook computer.

10. The mobile computer shell of claim 7, which is used for a palm-top computer.

11. The mobile computer shell of claim 7, which is used for an electronic dictionary.

12. The mobile computer shell of claim 7, which is used for a PDA (personal digital assistant).
